(19) United States
(12) Patent Application Publication
(10) Pub. No.: US 2016/0160074 A1
(43) Pub. Date: Jun. 9, 2016

(54) PHOTOIMPRINTING RESIN COMPOSITION SOLUTION, PHOTOIMPRINTING RESIN THIN FILM, AND PATTERNING METHOD

(71) Applicant: Industrial Technology Research Institute, Hsinchu (TW)

(72) Inventors: Yaw-Ting Wu, Taoyuan City (TW); Ping-Chen Chen, Taipei City (TW)

(21) Appl. No.: 14/583,793

(22) Filed: Dec. 29, 2014

(30) Foreign Application Priority Data
Dec. 4, 2014 (TW) 103142138

(51) Int. Cl. C09D 163/04; C09D 161/06

(52) U.S. Cl. CPC C09D 163/04; C09D 161/06

(57) ABSTRACT

A photoimprinting resin composition solution is provided. The photoimprinting resin composition solution includes a monomer or a polymer having an epoxy group, a cationic photopolymerization initiator, a thermoplastic resin, and a solvent. The weight-average molecular weight of the thermoplastic resin is 500 to 50000, and the thermoplastic resin does not react with the monomer or the polymer having an epoxy group and the cationic photopolymerization initiator.

### CROSS-REFERENCE TO RELATED APPLICATION

This application claims the priority benefit of Taiwan application serial no. 103142138, filed on Dec. 4, 2014. The entirety of the above-mentioned patent application is hereby incorporated by reference herein and made a part of this specification.

### TECHNICAL FIELD

The disclosure is related to a photoimprinting resin composition solution, a photoimprinting resin thin film, and a patterning method.

### BACKGROUND

With the vigorous development of the integrated circuit, the reduction in size and the integration of elements are inevitable trends, and the active development of those characteristics is an important topic of various industries. The etching process plays an important role in the integrated circuit manufacturing process. However, in the conventional lithography and etching process, a photoresist is manufactured into an etch mask via a lithography method, where the dimension and the aspect ratio of the structure are limited by optics. Therefore, bottleneck may occur when a micro-nano structure having a high aspect ratio is etched. Moreover, conventional lithography and etching techniques also have the disadvantage of a costly exposure machine.

In comparison to the conventional lithography process, the photoimprinting method has the advantage of faster production speed, and at the same time, due to the demand for larger substrate dimension and a refined pattern, adjustment to the machine of the photoimprinting method is also more flexible. Therefore, the photoimprinting method has the potential to become the main technique of the etching process. It should be mentioned that, the photoimprint resin used in the photoimprinting method is a key material in the process, and has a certain influence over the imprint forming quality, reducing imprint residue, and production yield.

### SUMMARY

A photoimprinting resin composition solution of the disclosure includes a monomer or a polymer having an epoxy group, a cationic photopolymerization initiator, a thermoplastic resin, and a solvent. The weight-average molecular weight of the thermoplastic resin is 500 to 50000, and the thermoplastic resin does not react with the monomer or the polymer having an epoxy group and the cationic photopolymerization initiator.

A patterning method of the disclosure includes preparing a photoimprinting resin composition solution, and then coating the photoimprinting resin composition solution on a substrate. Then, a pre-bake process is performed to remove the solvent in the photoimprinting resin composition solution so as to form a photoimprinting resin thin film. Then, an imprinting process is performed on the photoimprinting resin thin film via an imprint mold to pattern the photoimprinting resin thin film. Then, an irradiation step is performed to cure the patterned photoimprinting resin thin film. Lastly, the imprint mold is removed, and then the substrate is patterned by using the patterned photoimprinting resin thin film as an etch mask.

A photoimprinting resin thin film of the disclosure includes a monomer or a polymer having an epoxy group, a cationic photopolymerization initiator, and a thermoplastic resin. The weight-average molecular weight of the thermoplastic resin is 500 to 50000, and the thermoplastic resin does not react with the monomer or the polymer having an epoxy group and the cationic photopolymerization initiator.

To make the above features and advantages of the disclosure more comprehensible, several embodiments accompanied with drawings are described in detail as follows.

### BRIEF DESCRIPTION OF THE DRAWINGS

FIG. 1A to FIG. 1G are cross-sectional schematics of the process of a patterning method illustrated according to an embodiment of the disclosure.

### DETAILED DESCRIPTION OF DISCLOSED EMBODIMENTS

A photoimprinting resin composition solution of an embodiment of the disclosure can include a monomer or a polymer having an epoxy group, a cationic photopolymerization initiator, a thermoplastic resin, and a solvent. In particular, the thermoplastic resin does not react with the monomer or the polymer having an epoxy group and the cationic photopolymerization initiator. Each component of the photoimprinting resin composition solution of an embodiment of the disclosure is described in detail below.

The weight-average molecular weight of the thermoplastic resin is 500 to 50000, and the thermoplastic resin does not react with the monomer or the polymer having an epoxy group and the cationic photopolymerization initiator. In the present embodiment, the thermoplastic resin is, for instance, a phenol resin, polystyrene, polyacrylate, polycarbonate, or a cyclic olefin polymer. The phenol resin can include a structure shown in formula 1:

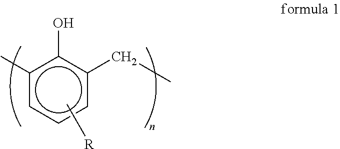

wherein R is a hydrogen atom or a methyl group, and n is 4 to 400.

The monomer or the polymer having an epoxy group can be one or a plurality of different monomers or polymers having an epoxy group. That is, the photoimprinting resin composition solution can contain one monomer or polymer having an epoxy group, and can also contain a plurality of different monomers or polymers having an epoxy group. In the present embodiment, the monomer having an epoxy group can include 1,4-cyclohexanedimethanol diglycidyl ether, bisphenol A diglycidyl ether, bis[4-(glycidyloxy)phenyl]methane, 1,4-butanediol diglycidyl ether, 1,2,7,8-diepoxyoctane, diglycidyl 1,2-cyclohexanedicarboxylate, N,N-diglycidyl-4-glycidyloxyaniline, 4,4′-methylenebis(N,N-diglycidylaniline), 3,4-epoxycyclohexylmethyl-3,4-epoxycyclohexanecarboxylate, neopentyl glycol diglycidyl ether, resorcinol diglycidyl ether, tris(4-hydroxyphenyl)methane triglycidyl ether, α-pinene oxide, 3-(1H,1H,5H-octafluoropentyloxy)-1,2-epoxypropane, or trimethoxy[2-(7-oxabicyclo[4.1.0]hept-3-yl)ethyl]silane. The polymer having an epoxy group can include poly[(phenyl glycidyl ether)-co-formaldehyde] or poly[(o-cresyl glycidyl ether)-co-formaldehyde]. The monomer or the polymer having an epoxy group can reduce the imprint temperature of the imprinting process.

The cationic photopolymerization initiator can include triarylsulfonium hexafluoroantimonate salt, triarylsulfonium hexafluorophosphate salt, diaryliodonium salt, or ferrocenium salt. In the present embodiment, a weight concentration 50% triarylsulfonium hexafluoroantimonate propylene carbonate solution is used for the cationic photopolymerization initiator. The cationic photopolymerization initiator can generate crosslinking and curing to the monomer or the polymer having an epoxy group in the formed photoimprinting resin thin film via an irradiation step. As a result, not only can the issue of a brittle imprint structure be alleviated, the etch resistance thereof can also be increased.

The solvent can include propylene glycol monomethyl ether acetate (PGMEA), propylene glycol propyl ether, anisole, or propylene carbonate. In the present embodiment, via the selection and the mixing of the solvent, the adhesion and the coating properties of the photoimprinting resin composition solution can be adjusted.

In the photoimprinting resin composition solution of the present embodiment, based on 100 parts by weight of the thermoplastic resin, the content of the monomer or the polymer having an epoxy group is 10 parts by weight to 500 parts by weight, the content of the cationic photopolymerization initiator is 1 part by weight to 50 parts by weight, and the content of the solvent is 50 parts by weight to 5000 parts by weight. In an embodiment, based on 100 parts by weight of the thermoplastic resin, the content of the monomer or the polymer having an epoxy group is 40 parts by weight to 400 parts by weight, the content of the cationic photopolymerization initiator is 5 part by weight to 40 parts by weight, and the content of the solvent is 100 parts by weight to 3000 parts by weight. In particular, based on 100 parts by weight of the thermoplastic resin, the content of the monomer or the polymer having an epoxy group is 80 parts by weight to 250 parts by weight, the content of the cationic photopolymerization initiator is 10 part by weight to 25 parts by weight, and the content of the solvent is 300 parts by weight to 1000 parts by weight.

According to another embodiment of the disclosure, in addition to including a solvent, a monomer or a polymer having an epoxy group, a cationic photopolymerization initiator, and a thermoplastic resin, the photoimprinting resin composition solution can further include an additive. The additive can include a photoacid generator, a surfactant, a polyol, or a combination thereof. In the present embodiment, by adding a photoacid generator, the peelability of the formed photoimprinting resin thin film can be increased; by adding a surfactant, the coating properties of the photoimprinting resin composition solution and the mold release properties of the formed photoimprinting resin thin film can be adjusted; by adding a polyol, the curing properties of the formed photoimprinting resin thin film in the irradiation step can be adjusted.

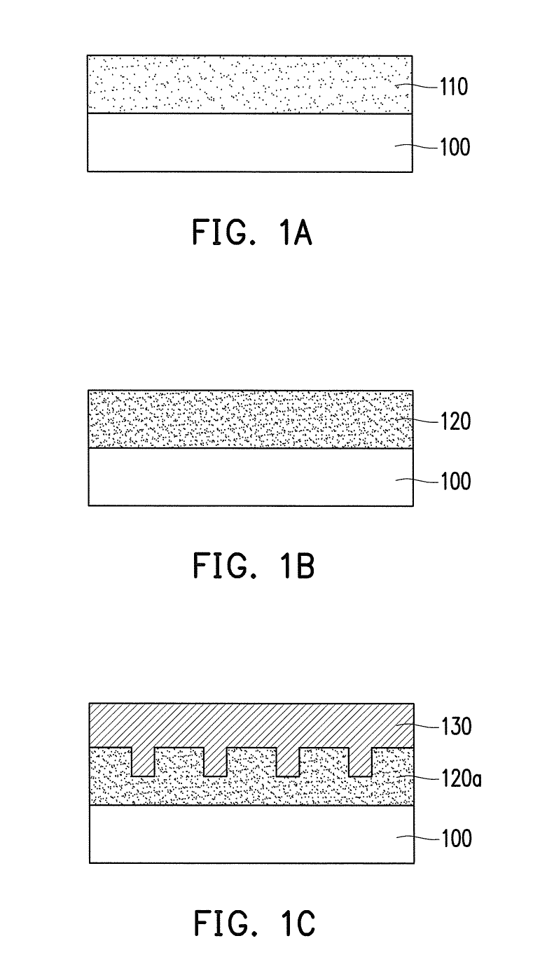

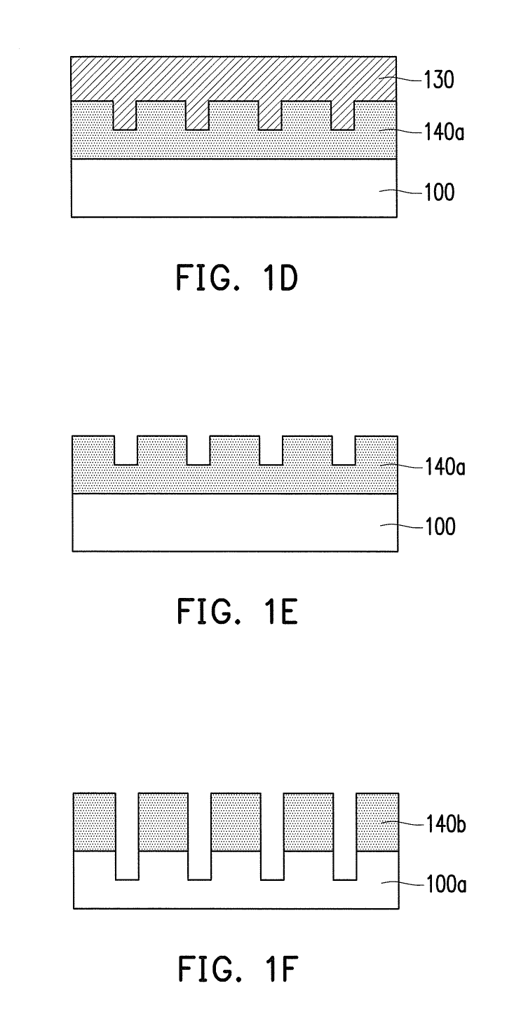

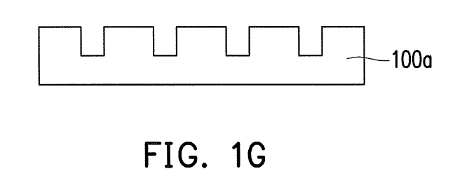

FIG. 1A to FIG. 1G are cross-sectional schematics of the process of a patterning method illustrated according to an embodiment of the disclosure. The patterning method includes forming a photoimprinting resin thin film via the photoimprinting resin composition solution of the above embodiments. The process of a patterning method of an embodiment of the disclosure is described in detail in the following with reference to figures.

Referring to FIG. 1A, a substrate 100 is provided. The substrate 100 is, for instance, a semiconductor material, a metal oxide semiconductor material, a metal material, or a substrate on which a specific element layer is formed.

Referring further to FIG. 1A, a photoimprinting resin composition solution is coated on the substrate 100 to form a photoimprinting resin composition solution coating layer 110. The coating process includes, for instance, a spin coating method or other known coating methods.

Then, referring to FIG. 1A and FIG. 1B, a pre-bake process is performed on the photoimprinting resin composition solution coating layer 110 to remove the solvent in the photoimprinting resin composition solution, so as to form a photoimprinting resin thin film 120 on the substrate 100. The pre-bake process includes, for instance, a thermal convection method, an infrared radiation method, or a heat conduction method, and the temperature thereof is about 50 degrees Celsius to about 150 degrees Celsius.

Based on the above, since a pre-bake process is performed to remove the solvent in the step of FIG. 1B, in the photoimprinting resin thin film 120 of the present embodiment, based on 100 parts by weight of the thermoplastic resin, the content of the monomer or the polymer having an epoxy group is 10 parts by weight to 500 parts by weight, and the content of the cationic photopolymerization initiator is 1 part by weight to 50 parts by weight.

Referring to FIG. 1B and FIG. 1C, an imprinting process is performed on the photoimprinting resin thin film 120 via an imprint mold 130 to form a patterned photoimprinting resin thin film 120a. More specifically, the imprint mold 130 has a specific imprint pattern, and is, for instance, a wiring pattern or a pattern of a specific element. The material of the imprint mold 130 can include a polymer material, a ceramic material, or other composite materials, and is, for instance, polydimethylsiloxane (PDMS), a cycloolefin polymer, or quartz glass. Moreover, the imprinting process can include a room temperature imprinting process or a heating imprinting process.

Then, referring to FIG. 1C and FIG. 1D, an irradiation step is performed on the patterned photoimprinting resin thin film 120a to cure the patterned photoimprinting resin thin film 120a, so as to form a patterned cured photoimprinting resin thin film 140a. In the present embodiment, the light used in the irradiation step is, for instance, UV light, but the disclosure is not limited thereto.

Referring to FIG. 1D and FIG. 1E, the imprint mold 130 is removed. Then, referring to FIG. 1E and FIG. 1F, a patterning process is performed on the substrate 100 by using the patterned cured photoimprinting resin thin film 140a as an etch mask to form a patterned cured photoimprinting resin thin film 140b and a patterned substrate 100a. The patterning process is, for instance, an etching process. The etching process can be an anisotropic etching process such as a dry etching process. Then, referring to FIG. 1F and FIG. 1G, the patterned cured photoimprinting resin thin film 140b is removed to form the patterned substrate 100a.

In the following, experimental examples are listed to describe in detail the photoimprinting resin composition solution provided in the above embodiments and characteristics thereof when applied in a patterning method. However, the following experimental examples are not intended to limit the disclosure.

### Experimental Example 1

### Preparation of Photoimprinting Resin Composition Solution

### Example 1

3 g of novolak solution A, 1 g of 1,4-cyclohexanedimethanol diglycidyl ether, and 0.16 g of weight concentration 50% triarylsulfonium hexafluoroantimonate propylene carbonate solution were mixed to form a photoimprinting resin composition solution. The novolak solution A is a phenol resin solution with PGMEA as the solvent, wherein the content of the phenol resin is 28 wt %, and the phenol resin is acresol/phenol resin obtained by polymerizing formaldehyde, dimethylphenol, and methyl phenol, and the weight-average molecular weight thereof is about 2000. The patterning method was performed via the photoimprinting resin composition solution. In particular, a pre-bake process was performed under a temperature of 120° C. for 300 s, the imprinting process was performed under a temperature of 80° C. with a pressure of 2.3 Kgf/cm² for 60 s, the irradiation step was performed by an UV exposure dose of 900 mj/cm², and the imprint mold was removed under a temperature of 70° C.

### Example 2

3 g of novolak solution A, 0.2 g of 1,4-cyclohexanedimethanol diglycidyl ether, and 0.096 g of weight concentration 50% triarylsulfonium hexafluoroantimonate propylene carbonate solution were mixed to form a photoimprinting resin composition solution. The novolak solution A is a phenol resin solution with PGMEA as the solvent, wherein the content of the phenol resin is 28 wt %, and the phenol resin is a cresol/phenol resin obtained by polymerizing formaldehyde, dimethylphenol, and methyl phenol, and the weight-average molecular weight thereof is about 2000. The patterning method was performed via the photoimprinting resin composition solution. In particular, a pre-bake process was performed under a temperature of 120° C. for 300 s, the imprinting process was performed under a temperature of 80° C. with a pressure of 2.3 Kgf/cm² for 60 s, the irradiation step was performed by an UV exposure dose of 900 mj/cm², and the imprint mold was removed under a temperature of 70° C.

### Example 3

3 g of novolak solution A, 0.5 g of 1,4-cyclohexanedimethanol diglycidyl ether, and 0.12 g of weight concentration 50% triarylsulfonium hexafluoroantimonate propylene carbonate solution were mixed to form a photoimprinting resin composition solution. The novolak solution A is a phenol resin solution with PGMEA as the solvent, wherein the content of the phenol resin is 28 wt %, and the phenol resin is a cresol/phenol resin obtained by polymerizing formaldehyde, dimethylphenol, and methyl phenol, and the weight-average molecular weight thereof is about 2000. The patterning method was performed via the photoimprinting resin composition solution. In particular, a pre-bake process was performed under a temperature of 120° C. for 300 s, the imprinting process was performed under a temperature of 80° C. with a pressure of 2.3 Kgf/cm² for 60 s, the irradiation step was performed by an UV exposure dose of 900 mj/cm², and the imprint mold was removed under a temperature of 70° C.

### Comparative Example

3 g of novolak solution A was used to perform a patterning method. The novolak solution A is a phenol resin solution with PGMEA as the solvent, wherein the content of the phenol resin is 28 wt %, and the phenol resin is a cresol/phenol resin obtained by polymerizing formaldehyde, dimethylphenol, and methyl phenol, and the weight-average molecular weight thereof is about 2000. In particular, a pre-bake process was performed under a temperature of 120° C. for 300 s, the imprinting process was performed under a temperature of 80° C. with a pressure of 2.3 Kgf/cm² for 60 s, the irradiation step was performed by an UV exposure dose of 900 mj/cm², and the imprint mold was removed under a temperature of 70° C.

### Evaluation of Imprint Formability and Mold Release Effect

Then, evaluations of imprint formability and mold release effect were performed on the photoimprinting resin thin films formed by the photoimprinting resin composition solutions of example 1 to example 3 in the patterning method and the photoimprinting resin thin film of the comparative example formed in the patterning method, and each evaluation result is shown in Table 1 below.

TABLE 1

| | | | Weight | | | |
|---|---|---|---|---|---|---|
| | | | concentration | | | |
| | | | 50% | | | |
| | | | triarylsulfonium | | | |
| | | | hexafluoroantimonate | | | |
| | | 1,4-cyclohexanedimethanol | propylene | | | |
| | Novolak | diglycidyl | carbonate | State after | Imprint | |
| | solution A | ether | solution | pre-bake | pattern | Mold release |
| | (g) | (g) | (g) | process | formability | property |
| Example 1 | 3 | 1 | 0.16 | Wet film | Good | Complete |
| | | | | | | mold release |
| Example 2 | 3 | 0.2 | 0.096 | Dry film | Fair | Complete |
| | | | | | | mold release |
| Example 3 | 3 | 0.5 | 0.12 | Dry film | Good | Complete |
| | | | | | | mold release |
| Comparative | 3 | 0 | 0 | Dry film | Poor | Resin |
| example | | | | | | fracture |
| | | | | | | sticks to the |
| | | | | | | mold |

It can be known from Table 1 that, in the comparative example, only novolak solution A is used as the component of the photoimprinting resin, the imprint pattern formability of the formed photoimprinting resin thin film is poor, and the imprinting resin fracture sticks to the mold. In comparison, in addition to novolak solution A, 1,4-cyclohexanedimethanol diglycidyl ether and triarylsulfonium hexafluoroantimonate are further added in the photoimprinting resin composition solutions of example 1 to example 3. It can be known from Table 1 that, the imprint pattern formability of the photoimprinting resin thin films formed by the photoimprinting resin composition solutions of example 1 to example 3 is good, and mold release thereof is complete. In comparison to the photoimprinting resin thin film formed by the solution of the comparative example, since the monomer having an epoxy group and the cationic photopolymerization initiator are added in the photoimprinting resin composition solutions of example 1 to example 3, the imprint pattern formability of the formed photoimprinting resin thin films can be increased, and mold release property thereof can be improved.

### Experimental Example 2

### Preparation of Photoimprinting Resin Composition Solution

### Example 4

3 g of novolak solution A, 1 g of 1,4-cyclohexanedimethanol diglycidyl ether, 0.16 g of weight concentration 50% triarylsulfonium hexafluoroantimonate propylene carbonate solution, and 0.6 g of PGMEA were mixed to form a photoimprinting resin composition solution. The novolak solution A is a phenol resin solution with PGMEA as the solvent, wherein the content of the phenol resin is 28 wt %, the phenol resin is a cresol/phenol resin obtained by polymerizing formaldehyde, dimethylphenol, and methyl phenol, and the weight-average molecular weight thereof is about 2000.

### Example 5

3 g of novolak solution A, 0.5 g of 1,4-cyclohexanedimethanol diglycidyl ether, 0.12 g of weight concentration 50% triarylsulfonium hexafluoroantimonate propylene carbonate solution, and 0.6 g of PGMEA were mixed to form a photoimprinting resin composition solution. The novolak solution A is a phenol resin solution with PGMEA as the solvent, wherein the content of the phenol resin is 28 wt %, the phenol resin is a cresol/phenol resin obtained by polymerizing formaldehyde, dimethylphenol, and methyl phenol, and the weight-average molecular weight thereof is about 2000.

### Example 6

3 g of novolak solution A, 0.8 g of bisphenol A diglycidyl ether, 0.18 g of weight concentration 50% triarylsulfonium hexafluoroantimonate propylene carbonate solution, and 0.6 g of PGMEA were mixed to form a photoimprinting resin composition solution. The novolak solution A is a phenol resin solution with PGMEA as the solvent, wherein the content of the phenol resin is 28 wt %, the phenol resin is a cresol/phenol resin obtained by polymerizing formaldehyde, dimethylphenol, and methyl phenol, and the weight-average molecular weight thereof is about 2000.

### Example 7

3 g of novolak solution A, 0.5 g of bisphenol A diglycidyl ether, 0.12 g of weight concentration 50% triarylsulfonium hexafluoroantimonate propylene carbonate solution, and 0.6 g of PGMEA were mixed to form a photoimprinting resin composition solution. The novolak solution A is a phenol resin solution with PGMEA as the solvent, wherein the content of the phenol resin is 28 wt %, the phenol resin is a cresol/phenol resin obtained by polymerizing formaldehyde, dimethylphenol, and methyl phenol, and the weight-average molecular weight thereof is about 2000.

### Measurement of Imprint Temperature

Then, the steps of FIG. 1A to FIG. 1E were performed on the photoimprinting resin composition solutions of example 4 to example 7. In particular, tests at different imprint temperatures were performed in the imprinting process, and each test result is shown in Table 2 below.

TABLE 2

| | | | | Weight | | |
|---|---|---|---|---|---|---|
| | | | | concentration | | |
| | | | | 50% | | |
| | | | | triarylsulfonium | | |
| | | | | hexafluoroantimonate | | |
| | | 1,4-cyclohexanedimethanol | Bisphenol A | propylene | | |
| | Novolak | diglycidyl | diglycidyl | carbonate | | |
| | solution A | ether | ether | solution | PGMEA | Imprint |
| | (g) | (g) | (g) | (g) | (g) | temperature |
| Example 4 | 3 | 1 | 0 | 0.16 | 0.6 | Imprint at |
| | | | | | | room |
| | | | | | | temperature |
| Example 5 | 3 | 0.5 | 0 | 0.12 | 0.6 | ≧50° C. |
| Example 6 | 3 | 0 | 0.8 | 0.18 | 0.6 | ≧60° C. |
| Example 7 | 3 | 0 | 0.5 | 0.12 | 0.6 | ≧70° C. |

It can be known from Table 2 that, in example 4 to example 7, different types of monomers having an epoxy group are respectively added, and different amounts thereof are added. Specifically, in example 4, 1 g of 1,4-cyclohexanedimethanol diglycidyl ether is added, and an imprinting process can be performed on the formed photoimprinting resin thin film under room temperature. In example 5, 0.5 g of 1,4-cyclohexanedimethanol diglycidyl ether is added, and an imprinting process can be performed on the formed photoimprinting resin thin film under a temperature of ≧50° C. In example 6, 0.8 g of bisphenol A diglycidyl ether is added, and an imprinting process can be performed on the formed photoimprinting resin thin film under a temperature of ≧60° C. In example 7, 0.5 g of bisphenol A diglycidyl ether is added, and an imprinting process can be performed on the formed photoimprinting resin thin film under a temperature of ≧70° C. It can therefore be known that, when preparing the photoimprinting resin composition solution of the disclosure, the imprint temperature of the photoimprinting resin thin film can be adjusted by adjusting the type and the amount of the monomer having an epoxy group. As a result, the patterning method of the disclosure can be performed via a room temperature imprinting process or a heating imprinting process.

### Experimental Example 3

### Preparation of Photoimprinting Resin Composition Solution

### Example 8

18 g of novolak solution A, 3 g of 1,4-cyclohexanedimethanol diglycidyl ether, 0.72 g of weight concentration 50% triarylsulfonium hexafluoroantimonate propylene carbonate solution, and 6 g of PGMEA were mixed to form a photoimprinting resin composition solution. The novolak solution A is a phenol resin solution with PGMEA as the solvent, wherein the content of the phenol resin is 28 wt %, the phenol resin is a cresol/phenol resin obtained by polymerizing formaldehyde, dimethylphenol, and methyl phenol, and the weight-average molecular weight thereof is about 2000.

### Example 9

15 g of novolak solution A, 2.5 g of bisphenol A diglycidyl ether, 0.6 g of weight concentration 50% triarylsulfonium hexafluoroantimonate propylene carbonate solution, and 7.5 g of PGMEA were mixed to fonn a photoimprinting resin composition solution. The novolak solution A is a phenol resin solution with PGMEA as the solvent, wherein the content of the phenol resin is 28 wt %, the phenol resin is a cresol/phenol resin obtained by polymerizing formaldehyde, dimethylphenol, and methyl phenol, and the weight-average molecular weight thereof is about 2000.

### Example 10

9 g of novolak solution A, 1.2 g of bisphenol A diglycidyl ether, 0.36 g of weight concentration 50% triarylsulfonium hexafluoroantimonate propylene carbonate solution, and 3.75 g of PGMEA were mixed to form a photoimprinting resin composition solution. The novolak solution A is a phenol resin solution with PGMEA as the solvent, wherein the content of the phenol resin is 28 wt %, the phenol resin is a cresol/phenol resin obtained by polymerizing formaldehyde, dimethylphenol, and methyl phenol, and the weight-average molecular weight thereof is about 2000.

### Example 11

9 g of novolak solution A, 1.8 g of 1,4-cyclohexanedimethanol diglycidyl ether, 0.38 g of weight concentration 50% triarylsulfonium hexafluoroantimonate propylene carbonate solution, and 5.25 g of PGMEA were mixed to form a photoimprinting resin composition solution. The novolak solution A is a phenol resin solution with PGMEA as the solvent, wherein the content of the phenol resin is 28 wt %, the phenol resin is a cresol/phenol resin obtained by polymerizing formaldehyde, dimethylphenol, and methyl phenol, and the weight-average molecular weight thereof is about 2000.

### Example 12

9 g of novolak solution B, 2.4 g of bisphenol A diglycidyl ether, 0.63 g of weight concentration 50% triarylsulfonium hexafluoroantimonate propylene carbonate solution, and 12 g of PGMEA were mixed to form a photoimprinting resin composition solution. The novolak solution B is a phenol resin solution with PGMEA as the solvent, wherein the content of the phenol resin is 35 wt %, the phenol resin is a cresol/phenol resin obtained by polymerizing formaldehyde, dimethylphenol, and methyl phenol, and the weight-average molecular weight thereof is about 2500.

### Example 13

9 g of novolak solution B, 2.15 g of bisphenol A diglycidyl ether, 0.62 g of weight concentration 50% triarylsulfonium hexafluoroantimonate propylene carbonate solution, and 12 g of PGMEA were mixed to form a photoimprinting resin composition solution. The novolak solution B is a phenol resin solution with PGMEA as the solvent, wherein the content of the phenol resin is 35 wt %, the phenol resin is a cresol/phenol resin obtained by polymerizing formaldehyde, dimethylphenol, and methyl phenol, and the weight-average molecular weight thereof is about 2500.

### Example 14

9 g of novolak solution A, 0.5 g of 1,4-cyclohexanedimethanol diglycidyl ether, 1.8 g of poly[(phenyl glycidyl ether)-co-formaldehyde], 0.51 g of weight concentration 50% triarylsulfonium hexafluoroantimonate propylene carbonate solution, and 5.5 g of PGMEA were mixed to form a photoimprinting resin composition solution. The novolak solution A is a phenol resin solution with PGMEA as the solvent, wherein the content of the phenol resin is 28 wt %, the phenol resin is a cresol/phenol resin obtained by polymerizing formaldehyde, dimethylphenol, and methyl phenol, and the weight-average molecular weight thereof is about 2000.

### Example 15

15 g of novolak solution B, 2 g of 1,4-cyclohexanedimethanol diglycidyl ether, 4.45 g of bisphenol A diglycidyl ether, 1.52 g of weight concentration 50% triarylsulfonium hexafluoroantimonate propylene carbonate solution, and 11.2 g of PGMEA were mixed to form a photoimprinting resin composition solution. The novolak solution B is a phenol resin solution with PGMEA as the solvent, wherein the content of the phenol resin is 35 wt %, the phenol resin is acresol/phenol resin obtained by polymerizing formaldehyde, dimethylphenol, and methyl phenol, and the weight-average molecular weight thereof is about 2500.

### Example 16

15.4 g of novolak solution B, 1.2 g of bisphenol A diglycidyl ether, 4.92 g of poly[(phenyl glycidyl ether)-co-formaldehyde], 1.37 g of weight concentration 50% triarylsulfonium hexafluoroantimonate propylene carbonate solution, and 8.9 g of PGMEA were mixed to form a photoimprinting resin composition solution. The novolak solution B is a phenol resin solution with PGMEA as the solvent, wherein the content of the phenol resin is 35 wt %, the phenol resin is a cresol/phenol resin obtained by polymerizing formaldehyde, dimethylphenol, and methyl phenol, and the weight-average molecular weight thereof is about 2500.

### Measurement of Etch Rate

The commercial product epoxy imprint resin and the photoimprinting resin composition solutions of example 8 to example 16 were applied in the processing steps of FIG. 1A to FIG. 1F. Half of the patterned cured photoimprinting resin thin film of FIG. 1E was covered by a sapphire wafer to protect the imprint structure thereof from etching and bombardment by the etching gas in the etching process, and then an etching process was performed by using a BCl₃ gas system via an inductively coupled plasma (ICP) etching method. The etching time was 10 minutes, and upon completion, the covering sapphire wafer was removed. Then, an SEM cross-sectional analysis was performed, and the height of the imprint resin structure of the area covered by the sapphire wafer and the height of the imprint resin structure of the area not covered by the sapphire wafer were measured. Next, the height of the imprint resin structure of the area not covered by the sapphire wafer was subtracted from the height of the imprint resin structure of the area covered by the sapphire wafer, the result was divided by the etching time to obtain the etch rate of the imprint resin, and the measurement result of the etch rate of each embodiment is shown in Table 3 below.

TABLE 3

| | | | | | | Weight | | |
|---|---|---|---|---|---|---|---|---|
| | | | | | | concentration 50% | | |
| | | | | | | triarylsulfonium | | |
| | | | 1,4-cyclohexanedimethanol | | Poly[(phenyl | hexafluoroantimonate | | |
| | Novolak | Novolak | diglycidyl | Bisphenol A | glycidyl ether)- | propylene carbonate | | |
| | solution A | solution B | ether | diglycidyl | co-formaldehyde] | solution | PGMEA | Etch rate |
| | (g) | (g) | (g) | ether (g) | (g) | (g) | (g) | (nm/min) |
| Example 8 | 18 | 0 | 3 | 0 | 0 | 0.72 | 6 | 126 |
| Example 9 | 15 | 0 | 0 | 2.5 | 0 | 0.6 | 7.5 | 110 |
| Example 10 | 9 | 0 | 0 | 1.2 | 0 | 0.36 | 3.75 | 104 |
| Example 11 | 9 | 0 | 1.8 | 0 | 0 | 0.38 | 5.25 | 140 |
| Example 12 | 0 | 9 | 0 | 2.4 | 0 | 0.63 | 12 | 121 |
| Example 13 | 0 | 9 | 0 | 2.15 | 0 | 0.62 | 12 | 142 |
| Example 14 | 9 | 0 | 0.5 | 0 | 1.8 | 0.51 | 5.5 | 120 |
| Example 15 | 0 | 15 | 2 | 4.45 | 0 | 1.52 | 11.2 | 152 |
| Example 16 | 0 | 15.4 | 0 | 1.2 | 4.92 | 1.37 | 8.9 | 109 |
| Commercial | — | — | — | — | — | — | — | 165 |
| product | | | | | | | | |
| Epoxy | | | | | | | | |
| imprint gel | | | | | | | | |

It can be known from Table 3 that, the etch rate of the commercial product epoxy imprint resin is 165 nm/min, and the etch rates of the photoimprinting resin thin films of example 8 to example 16 are all lower than 165 nm/min. Therefore, the etch rates of the photoimprinting resin thin films of example 8 to example 16 are slower. That is, the photoimprinting resin thin films formed by the photoimprinting resin composition solutions of example 8 to example 16 have superior etch resistance.

Based on the above, since the photoimprinting resin composition solution provided in the disclosure includes a monomer or a polymer having an epoxy group, the imprint temperature of the formed photoimprinting resin thin film can be reduced. Moreover, since the photoimprinting resin composition solution provided in the disclosure also includes a cationic photopolymerization initiator, crosslinking and curing can be generated to the monomer or the polymer having an epoxy group in the formed photoimprinting resin thin film via an irradiation step. As a result, not only can the issue of a brittle imprint structure be alleviated, the etch resistance thereof can also be increased. Moreover, when applied in a lithography and etching process of a semiconductor or metal oxide, the photoimprinting resin composition solution of the disclosure further has the advantages of lower investment in equipment and simplified process.

Although the disclosure has been described with reference to the above embodiments, it will be apparent to one of the ordinary skill in the art that modifications and variations to the described embodiments may be made without departing from the spirit and scope of the disclosure. Accordingly, the scope of the disclosure will be defined by the attached claims not by the above detailed descriptions.

1. A photoimprinting resin composition solution, comprising:
a monomer or a polymer having an epoxy group;
a cationic photopolymerization initiator;
a thermoplastic resin, wherein a weight-average molecular weight of the thermoplastic resin is 500 to 50000, and the thermoplastic resin does not react with the monomer or the polymer having an epoxy group and the cationic photopolymerization initiator, and the thermoplastic resin is a phenol resin comprising a structure shown in formula 1: 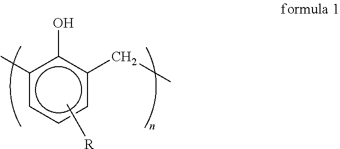
wherein R is a hydrogen atom or a methyl group, and n is 4 to 400; and
a solvent.

2. (canceled)

3. (canceled)

4. The photoimprinting resin composition solution of claim 1, wherein the monomer or the polymer having an epoxy group comprises one or a plurality of different monomers or polymers having an epoxy group.

5. The photoimprinting resin composition solution of claim 1, wherein based on 100 parts by weight of the thermoplastic resin, a content of the monomer or the polymer having an epoxy group is 10 parts by weight to 500 parts by weight, a content of the cationic photopolymerization initiator is 1 part by weight to 50 parts by weight, and a content of the solvent is 50 parts by weight to 5000 parts by weight.

6. The photoimprinting resin composition solution of claim 1, wherein the monomer or the polymer having an epoxy group comprises 1,4-cyclohexanedimethanol diglycidyl ether, bisphenol A diglycidyl ether, bis[4-(glycidyloxy)phenyl]methane, 1,4-butanediol diglycidyl ether, 2,7,8-diepoxyoctane, diglycidyl 1,2-cyclohexanedicarboxylate, N,N-diglycidyl-4-glycidyloxyaniline, 4,4′-methylenebis(N,N-diglycidylaniline), 3,4-epoxycyclohexylmethyl-3,4-epoxycyclohexanecarboxylate, neopentyl glycol diglycidyl ether, resorcinol diglycidyl ether, tris(4-hydroxyphenyl)methane triglycidyl ether, α-pinene oxide, 3-(1H,1H,5H-octafluoropentyloxy)-1,2-epoxypropane, trimethoxy[2-(7-oxabicyclo[4.1.0]hept-3-yl)ethyl]silane, poly[(phenyl glycidyl ether)-co-formaldehyde]), or poly[(o-cresyl glycidyl ether)-co-formaldehyde].

7. The photoimprinting resin composition solution of claim 1, wherein the cationic photopolymerization initiator comprises triarylsulfonium hexafluoroantimonate salt, triarylsulfonium hexafluorophosphate salt, diaryliodonium salt, or ferrocenium salt.

8. The photoimprinting resin composition solution of claim 1, further comprising an additive comprising a photoacid generator, a surfactant, a polyol, or a combination thereof.

9. A patterning method, comprising:
preparing a photoimprinting resin composition solution as described in claim 1;
coating the photoimprinting resin composition solution on a substrate;
performing a pre-bake process to remove the solvent in the photoimprinting resin composition solution so as to form a photoimprinting resin thin film;
performing an imprinting process on the photoimprinting resin thin film via an imprint mold to pattern the photoimprinting resin thin film;
performing an irradiation step to cure the patterned photoimprinting resin thin film;
removing the imprint mold; and
patterning the substrate by using the patterned photoimprinting resin thin film as an etch mask.

10. The patterning method of claim 9, wherein the imprinting process is a room temperature imprinting process or a heating imprinting process.

11. A photoimprinting resin thin film, comprising:
a monomer or a polymer having an epoxy group;
a cationic photopolymerization initiator; and
a thermoplastic resin, wherein a weight-average molecular weight of the thermoplastic resin is 500 to 50000, and the thermoplastic resin does not react with the monomer or the polymer having an epoxy group and the cationic photopolymerization initiator, and the thermoplastic resin is a phenol resin comprising a structure shown in formula 1: 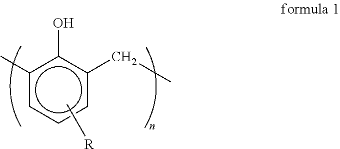
wherein R is a hydrogen atom or a methyl group, and n is 4 to 400.

12. (canceled)

13. (canceled)

14. The photoimprinting resin thin film of claim 11, wherein the monomer or the polymer having an epoxy group comprises one or a plurality of different monomers or polymers having an epoxy group.

15. The photoimprinting resin thin film of claim 11, further comprising an additive comprising a photoacid generator, a surfactant, a polyol, or a combination thereof.

16. The photoimprinting resin thin film of claim 11, wherein based on 100 parts by weight of the thermoplastic resin, a content of the monomer or the polymer having an epoxy group is 10 parts by weight to 500 parts by weight, and a content of the cationic photopolymerization initiator is 1 part by weight to 50 parts by weight.

17. The photoimprinting resin thin film of claim 11, wherein the monomer or the polymer having an epoxy group comprises 1,4-cyclohexanedimethanol diglycidyl ether, bisphenol A diglycidyl ether, bis[4-(glycidyloxy)phenyl]methane, 1,4-butanediol diglycidyl ether, 1,2,7,8-diepoxyoctane, diglycidyl 1,2-cyclohexanedicarboxylate, N,N-diglycidyl-4-glycidyloxyaniline, 4,4′-methylenebis(N,N-diglycidylaniline), 3,4-epoxycyclohexylmethyl-3,4-epoxycyclohexanecarboxylate, neopentyl glycol diglycidyl ether, resorcinol diglycidyl ether, tris(4-hydroxyphenyl)methane triglycidyl ether, α-pinene oxide, 3-(1H,1H,5H-octafluoropentyloxy)-1,2-epoxypropane, trimethoxy[2-(7-oxabicyclo[4.1.0]hept-3-yl)ethyl]silane, poly[(phenyl glycidyl ether)-co-formaldehyde]), or poly[(o-cresyl glycidyl ether)-co-formaldehyde].

18. The photoimprinting resin thin film of claim 11, wherein the cationic photopolymerization initiator comprises triarylsulfonium hexafluoroantimonate salt, triarylsulfonium hexafluorophosphate salt, diaryliodonium salt, or ferrocenium salt.
